(19) United States
(12) Patent Application Publication
(10) Pub. No.: US 2009/0182543 A1
(43) Pub. Date: Jul. 16, 2009

(54) AUTOMATIC VOXEL SELECTION FOR PHARMACOKINETIC MODELING

(75) Inventors: Timo Paulus, Aachen (DE); Mark Christof Wengler, Heidenheim An Der Brenz (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philps Electronics N.V., Eindhoven (NL)

(21) Appl. No.: 12/306,286

(22) PCT Filed: Jun. 29, 2007
(86) PCT No.: PCT/IB2007/052533

§ 371 Date: Dec. 23, 2008

(30) Foreign Application Priority Data
Jul. 3, 2006 (EP) 06116529.6

(51) Int. Cl. G06G 7/48; G06N 5/02

(52) U.S. Cl. 703/11; 706/47

(57) ABSTRACT

This relates to a method of automatically selecting preferred voxels from a group of voxels for pharmacokinetic modeling of a biological system, where the voxels contain data points indicating a change of activity-levels over time. For each respective voxel the changes of the data points over time with at least one noise level value, where the comparing is performed in accordance to a pre-defined selection rule. Then, those voxels where the result of the comparing obeys the selection rule are then selected as preferred voxels.

### FIELD OF INVENTION

The present invention relates to a method and an apparatus for automatically selecting preferred voxels from a group of voxels for pharmacokinetic modeling, where the voxels contain time series of data points indicating a change of activity-levels over time. The present invention further relates to a use of the method for analyzing an absorption or disposition of a drug or a compound in an organism or biological system.

### BACKGROUND OF THE INVENTION

The term pharmacokinetics refers to the branch of pharmacology dedicated to the study of the time course of substances and their relationship with organism or system. This discipline is applied mainly to drug substances and contrast agents, but could just as well concern itself with all manner of compounds residing within biological systems.

An important aspect for routine use of pharmacokinetic modeling in a clinical environment is the time needed to perform such an analysis. In that context, the workflow can be split up into two parts. The first part consists of the preparation or pre-processing of the data, where the clinician needs to view the complete data-set in order to define which data-points (s)he wants to analyze. Such data-set typically comprises data points indicating a change of activity-levels over time, such as a disposition process of a compound or substance within a system. Thus, the main step is to manually delineate the volumes-of-interests (VOIs), i.e. selecting preferred voxels. However, this can be a very time-consuming and tedious procedure. The second part is the computation time of the analysis algorithm. Clearly, this part is dependent of the first part, i.e. the less time the clinician has invested in selecting voxels for further processing, the longer the second part will take, and vice verse, the longer time the clinician has invested in selecting voxels the shorter will be computation time be. As an example, if the noise level of a voxel is of the same magnitude as the changes of the activity levels over time, the voxel can inherently not represent any meaningful parameter values, whereas a low noise level would save computation time of the analysis algorithm and simultaneously provide meaningful parameter values. Therefore, it would not make sense to fit voxels with high noise levels at all.

### BRIEF DESCRIPTION OF THE INVENTION

The object of the present invention is to provide a highly effective method in selecting preferred voxels in a much more efficient way, thereby saving the computation time of the analysis algorithm and enhance the quality of the analysis.

According to one aspect the present invention relates to a method of automatically selecting preferred voxels from a group of voxels for pharmacokinetic modeling, where the voxels contain time series of data points indicating a change of activity-levels over time, the method comprising:

comparing, for each respective voxel, the changes of the data points over time with at least one noise level value, the comparison being performed in accordance to a pre-defined selection rule, and

selecting those voxels where the result of the comparing obeys the selection rule.

Therefore, a very time saving method is provided for selecting preferred voxels that contain reliable data for further processing. Further, since it is secured that only those voxels will be selected that contain reliable data, the computation time of the analysis algorithms will be highly reduced. Also, since misleading results based on noisy data will not be displayed, the results from processing the voxels for the clinician will be more reliable.

In an embodiment, the selection rule is defined by:

max A(t)−min A(t)≧c·σ(t),

where max A(t) and min A(t) are the maximum and minimum activity-level values at time t, respectively, σ (t) is the noise level value at time t and c is a constant. Accordingly, the equation states that the voxels where the “dynamic” in the distribution of the data points is larger/equal by the factor c than the noise level will be acceptable and considered as preferred voxels. The factor c is in that sense considered as a threshold value that is typically selected by the clinician or a technician. The selection of the factor c may depend on the application or the accuracy required for processing the data points. In an embodiment, the noise level value σ is given by σ(t)=p·A(t) with p as a fixed percentage, wherein σ comprises the maximum σ(t) value. The noise factor σ may alternatively also be estimated based on various factors, e.g. from a Poisson model for the noise, from a Gauss model for the noise, from experimental setups or from a reconstruction method.

In an embodiment, the selection rule is defined by:

$$\frac{\vert A ( {t}_{i + 1} ) - A ( {t}_{i} ) \vert}{{t}_{i + 1} - {t}_{i}} \geq c \cdot ( σ ( {t}_{i + 1} ) + σ ( {t}_{i} ) ) ,$$

where A(tᵢ₊₁) and A(tᵢ) are the activity-level values between two successive data points at time tᵢ₊₁ and tᵢ, respectively, a (tᵢ₊₁) and a (tᵢ) are the associated noise levels between the two successive points, and i=1 . . . N−1, where N is the number of time-points tᵢ at which the activity has been measured. Accordingly, the activity between two successive time-points is compared to the noise at these times, which gives a very reliable way of filtering out those voxels that are not preferred for further processing. The reason for normalizing the change in the activity to the time interval between to successive points is because for measurements in quick succession the activity changes will most likely be small.

In an embodiment, the selection rule is defined by:

$$c \geq \frac{\sqrt{{\sum }_{i = 1}^{N} \frac{σ ( {t}_{i} )}{A ( {t}_{i} )}}}{N}$$

where σ(tᵢ) and A(tᵢ) are the noise level and activity-level values at time tᵢ, and N is the number of time-points tᵢ at which the activity has been measured. Accordingly, if this value is smaller than the threshold value c that is e.g. selected by a technician or clinician the voxel is accepted as preferred voxel.

In an embodiment, the step of comparing the changes of the data points over time with at least one noise level value comprises determining the correlation coefficient of the data point distribution, wherein those voxels having a correlation coefficient in accordance to a pre-defined threshold value are selected as preferred voxels.

According to another aspect, the method relates to a computer readable medium for storing instructions for enabling a processing unit to execute the above mentioned method steps.

In still another aspect, the present invention relates to a use of the method for analyzing an absorption or disposition of a drug or a compound in an organism or biological system posterior to the administering of the drug or the compound to the organism or the biological system.

In yet another aspect, the present invention relates to an apparatus adapted to automatically selecting preferred voxels from a group of voxels for pharmacokinetic modeling, where the voxels contain time series of data points indicating a change of activity-levels over time, comprising:

a memory for storing a pre-defined selection rule,

a processor adapted to compare, for each respective voxel, the changes of the data points over time with at least one noise level value, the comparing being performed in accordance to the selection rule, and

a processor adapted to select those voxels where the result of the comparing obeys the selection rule.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a flowchart illustrating an embodiment of a method according to the present invention of automatically selecting preferred voxels from a group of voxels for pharmacokinetic modeling, and

FIG. 2 shows an apparatus according to the present invention to automatically selecting preferred voxels from a group of voxels for pharmacokinetic modeling, and

FIG. 3 shows exemplary data for two voxels.

### DESCRIPTION OF EMBODIMENTS

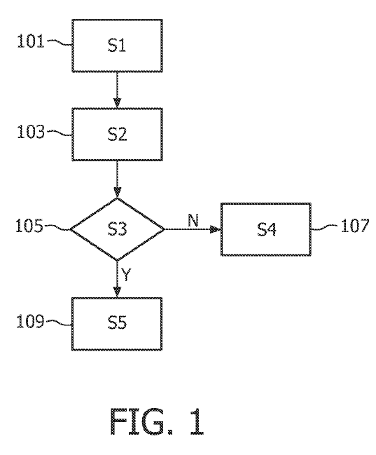

FIG. 1 shows a flowchart illustrating an embodiment of a method according to the present invention of automatically selecting preferred voxels from a group of voxels for pharmacokinetic modeling, where the voxel contain data points indicating a change of activity-levels over time. The term voxel means according to the present invention a volume element or a sample collected from a biological system containing the data. The group of voxels can e.g. comprise a number of samples that have been collected from the biological system. The biological system may e.g. be a human or animal body, or any kind of biological species. The term pharmacokinetic modeling means according to the present invention the study of absorption and/or disposition of a drug or compound of the biological system, where it is explored what the biological system does to the drug/compound. Accordingly, the absorption may relate to the amount of a drug/compound dose which gets into the biological system, e.g. via the bloodstream, during or after the administration of the compound/drug, whereas the disposition may relate to the dispose of the dose from the biological system. It follows that the term activity-level means according to the present invention the concentration of the drug/compound in the biological system, and the term change of activity-level over time means how the absorption or the disposition of the drug/compound dose change as a function of time.

This invention relates to automatically selecting those voxels from the group of voxels by determining whether the magnitude of the noise of the data points or the data point distribution compared to the dynamics of the activity-levels distribution over time is acceptable or not. By selecting out the voxels that provide the best data (low noise level) for subsequent processing the most meaningful parameter values can be determined from the voxels in much shorter time than otherwise. It should be inherent that the term noise level means according to the present invention the noise or the uncertainty value in one or more of the data points, or in the data point distribution that reflects the changes of the activity levels over time, i.e. the noise can be e.g. related to the correlation parameter in the data point distribution.

Referring to the flowchart in FIG. 1, initially the selection rule must be defined (S1) 101 that contains a comparison or mathematical operation between the data points and the noise level, wherein based on the comparison the quality of the data distribution contained in the voxels is evaluated. As will be discussed in more details later the selection rule is a way of evaluating the noise or the uncertainty in the data with the aim of defining a kind of “filter” for selecting the preferred voxels that provide high quality data. An important aspect for routine usage of pharmacokinetic modeling in a clinical environment is the time needed for analyzing what voxels provide the best data set, and therefore are preferred for further processing or analyzes. As mentioned previously, it is very time consuming to manually select those voxels that provide acceptable data sets for further analyzing. By implementing a selection rule as defined in (S1) 101 a filtering criterion is provided that selects only those voxels that provide good/acceptable data.

In the subsequent step (S2) 103 the data points are analyzed in accordance with the selection rule, i.e. the dynamic of the data point distribution is compared to a noise level value. If the result of the comparison operation is not in accordance to the selection rule (S3) 105 the voxels will not be used for further processing (S4) 107. This could e.g. be the case where the noise is of the same order of magnitude as the dynamics of the data point distribution. Clearly, the processing of such voxel(s) could not give any meaningful parameter values due to the large uncertainty in the data and would only result in less reliable evaluation of the results for the clinician. If on the other hand the result of the comparison operation is in accordance to the selection rule (S3) 105 the voxel(s) will be considered as preferred voxels (S5) 109.

In one embodiment, the selection rule as defined in step (S1) 101 is defined by the equation:

max A(t)−min A(t)≧c·σ(t), (1)

where max A(t) and min A(t) are the maximum and minimum activity-level values at time t, respectively, σ(t) is the noise level value at time t and c is a constant. In this embodiment the noise level value σ(t) is defined by the equation:

σ(t)=p·A(t), (2)

with p as a fixed percentage, wherein σ(t) may comprise the maximum σ(t) value, i.e. σ(t)=max σ(t). Accordingly, the selection rule defined by equation (1) states that a voxel is considered as a preferred voxel if the dynamic in the data point distribution is larger by the factor c than the noise level. The above equation can be rewritten as (1−cp) max A(t)≧min A(t). The factor c may in that sense be considered as a threshold value that is typically selected by the clinician or a technician. The selection of the factor c may depend on the application or the accuracy required for processing the data.

In another embodiment, the selection rule as defined in step (S1) 101 is given by the equation:

$$\frac{\vert A ( {t}_{i + 1} ) - A ( {t}_{i} ) \vert}{{t}_{i + 1} - {t}_{i}} \geq c \cdot ( σ ( {t}_{i + 1} ) + σ ( {t}_{i} ) ) \qquad ( 3 )$$

where A(tᵢ₊₁) and A(tᵢ) are the activity-level values between two successive points at time tᵢ₊₁ and tᵢ, respectively, σ(tᵢ₊₁) and σ(tᵢ) are the associated noise levels between the two successive points, and i=1 . . . N−1, where N is the number of time-points tᵢ at which the activity has been measured. In an embodiment, the noise level is estimated from bootstrap simulations as reported in scientific literature Buvat, I.: A Non-Parametric Bootstrap Approach for Analysing the Statistical Properties of SPECT and PET images, Phys. Med. Bio., 47, pp. 1761-75, 2002 and as reported in scientific literature Dahlbom, M.: Estimation of Image Noise in PET using the Bootstrap Method, IEEE TANS, Vol. 49, No. 5, pp. 2062-66, 2002; both enclosed as a reference herewith.

In still another embodiment, the selection rule as defined in step (S1) 101 is defined by the equation:

$$c \geq \frac{\sqrt{{\sum }_{i = 1}^{N} \frac{σ ( {t}_{i} )}{A ( {t}_{i} )}}}{N} \qquad ( 4 )$$

where σ(tᵢ) and A(tᵢ) are the noise level and activity-level values at time tᵢ, and N is the number of time-points tᵢ at which the activity has been measured. This method calculates the mean relative error of the data point distribution as the root mean square value of the relative noise values for each time-point. Accordingly, if the value is smaller than the threshold value c the voxel will be accepted as a preferred voxel. Other voxels will be neglected (non-preferred voxels).

The noise value σ in equations (1)-(4) may also be estimated based on various factors, e.g. from a Poisson model for the noise, from a Gauss model for the noise, from experimental setups, from a reconstruction method and the like. The above embodiments are just meant to illustrate a few possible implementations of selection criteria.

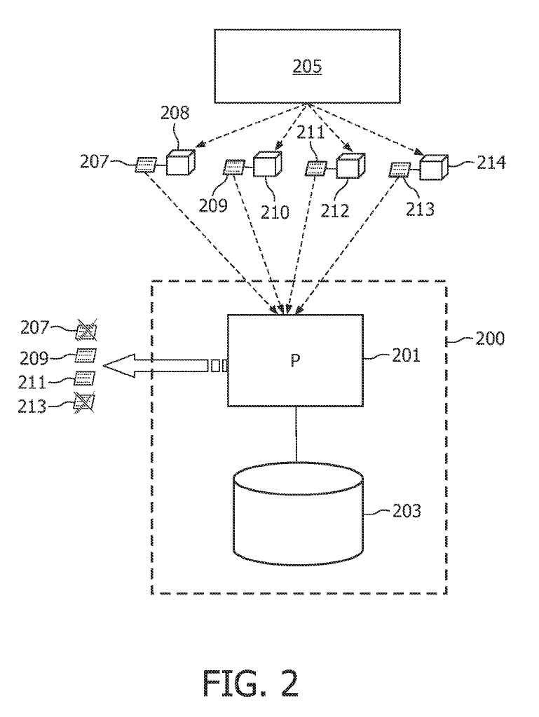

FIG. 2 shows an apparatus 200 according to the present invention to automatically select preferred voxels from a group of voxels 208, 210, 212, 214 for pharmacokinetic modeling, where the voxels contain sets of data 207, 209, 211, 213 showing the change of activity-levels over time. As shown here, the apparatus comprises a memory 203 for storing at least one pre-defined selection rule and/or software for instructing the processor (P) 201 to perform the method steps in FIG. 1. Accordingly, the processor (P) 201 compares, for each respective voxel 208, 210, 212, 214, the changes of the data points over time with at least one noise level value in accordance to the selection rule. The processor (P) 201 and the memory 203 can be a standard hardware components in a computer system comprised in the apparatus 200, or in any kind of device. In this embodiment, the processor (P) 201 is further adapted to select out those voxels where the result of the comparing obeys the selection rule. As illustrated here, the data sets 207 and 213 will not be used for further processing due to too large noise level, whereas data set 209 and 211 are considered as preferred data sets.

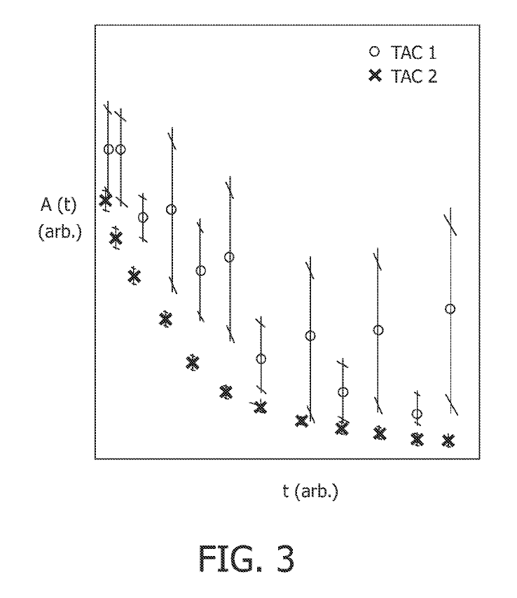

FIG. 3 illustrates exemplary data for two voxels, TAC 1 and TAC 2. The term TAC refers to time-activity-curve (shown in arbitrary units (arb.)) that simply refers to the changes of the activity levels A(t) over time t. Accordingly, the noise level of the TACs are compared to the dynamics, i.e. the change of the TACs over time. As mentioned previously, this can be implemented in various ways, e.g. as shown in equations (1)-(4). Since the noise level for TAC 1 is of similar magnitude as the dynamic of the TAC 1 it should be inherent that the voxel for TAC 1 is not a preferred candidate for further processing, whereas TAC 2 is obviously suitable for further processing due to the low noise level.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the scope of this invention. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. A method of automatically selecting preferred voxels (209, 211) from a group of voxels (208, 210, 212, 214) for pharmacokinetic modeling, where the voxels contain time series of data points indicating a change of activity-levels over time, the method comprising:
comparing (103), for each respective voxel, the changes of the data points over time with at least one noise level value, the comparison being performed in accordance to a pre-defined selection rule (101), and
selecting (109) those voxels where the result of the comparing obeys the selection rule.

2. A method according to claim 1, wherein the selection rule is defined by:
max A(t)−min A(t)≧c·σ(t),
where max A(t) and min A(t) are the maximum and minimum activity-level values at time t, respectively, σ(t) is the noise level value at time t and c is a constant.

3. A method according to claim 2, wherein the noise level value σ is given by:
σ(t)=p·A(t),
with p as a fixed percentage, wherein σ comprises the maximum σ(t) value.

4. A method according to claim 1, wherein the selection rule is defined by:
$$\frac{\vert A ( {t}_{i + 1} ) - A ( {t}_{i} ) \vert}{{t}_{i + 1} - {t}_{i}} \geq c \cdot ( σ ( {t}_{i + 1} ) + σ ( {t}_{i} ) ) ,$$
where A(tᵢ₊₁) and A(tᵢ) are the activity-level values between two successive data points at time tᵢ₊₁ and tᵢ, respectively, σ(tᵢ₊₁) and σ(tᵢ) are the associated noise levels between the two successive points, and i=1 . . . N−1, where N is the number of time-points tᵢ at which the activity has been measured.

5. A method according to claim 1, wherein the selection rule is defined by:
$$c \geq \frac{\sqrt{{\sum }_{i = 1}^{N} \frac{σ ( {t}_{i} )}{A ( {t}_{i} )}}}{N}$$
where σ(tᵢ) and A(tᵢ) are the noise level and activity-level values at time tᵢ, and N is the number of time-points tᵢ at which the activity has been measured.

6. A method according to claim 1, wherein the step of comparing the changes of the data points over time with at least one noise level value comprises determining the correlation coefficient of the data point distribution, wherein those voxels having a correlation coefficient in accordance to a pre-defined threshold value are selected as preferred voxels.

7. A method according to claim 1, wherein at least one noise level value is selected from a group consisting of noise level values determined from a Poisson model for the noise, from a Gauss model for the noise, from experimental setups or from a reconstruction method.

8. A computer readable medium for storing instructions for enabling a processing unit to execute the method in claim 1.

9. A use of a method as claimed in claim 1 for analyzing an absorption or disposition of a drug or a compound in an organism or biological system posterior to the administering of the drug or the compound to the organism or the biological system.

10. An apparatus (200) adapted to automatically selecting preferred voxels (209, 211) from a group of voxels (208, 210, 212, 214) for pharmacokinetic modeling, where the voxels contain time series of data points indicating a change of activity-levels over time, comprising:
a memory (203) for storing a pre-defined selection rule,
a processor (201) adapted to compare, for each respective voxel, the changes of the data points over time with at least one noise level value, the comparing being performed in accordance to the selection rule, and
a processor (201) adapted to select those voxels (209, 211) where the result of the comparing obeys the selection rule.
